(19) United States
(12) Patent Application Publication
(10) Pub. No.: US 2022/0111461 A1
(43) Pub. Date: Apr. 14, 2022

(54) WELDING-TYPE POWER SUPPLIES WITH OVERRIDE OF AUTO-POLARITY SELECTION

(71) Applicant: Illinois Tool Works Inc., Glenview, IL (US)

(72) Inventor: Jake Zwayer, Appleton, WI (US)

(21) Appl. No.: 17/066,133

(22) Filed: Oct. 8, 2020

(51) Int. Cl. B23K 9/10

(52) U.S. Cl. CPC B23K 9/1062; B23K 9/1087

(57) ABSTRACT

Systems and methods for setting the polarity of welding-type power provided by a welding-type power supply. The output polarity may be automatically selected based on one or more selectable welding parameters. The automatically selected polarity may be overridden based on operator input.

### TECHNICAL FIELD

The present disclosure generally relates to welding-type power systems and, more particularly, to welding-type systems configured to automatically select the output power polarity and override the automatically selected output power polarity.

### BACKGROUND

Some welding-type systems, are configured to automatically select an output polarity, for example based on a selected welding process. In some welding operations, it may be desirable to override an automatically selected output polarity.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to welding-type systems configured to override, based on operator input, automatically selected output power polarities, substantially as illustrated by and/or described in connection with at least one of the figures, and as set forth more completely in the claims.

### BRIEF DESCRIPTION OF THE DRAWINGS

FIG. 1a shows an example welding-type system including a welding-type power supply configured automatically select an output power polarity for a welding operation and override the automatically selected output power polarity based on operator input, in accordance with aspects of this disclosure.

FIG. 1b is a block diagram of the welding system of FIG. 1a illustrating communication between a remote device and the welding-type power supply, in accordance with aspects of this disclosure.

FIG. 2 is a flow diagram illustrating an example method of selecting an output power polarity, in accordance with aspects of this disclosure.

The figures are not necessarily to scale. Where appropriate, the same or similar reference numerals are used in the figures to refer to similar or identical elements.

### DETAILED DESCRIPTION

The efficiency of a welding-type operation is affected by the polarity of the power provided to the welding operation. The polarity is based on the attachment of welding electrodes to a welding-type power supply (e.g., which cable is attached to the welding torch and which cable is attached to the workpiece) and/or by controlling the polarity of the power at the terminals using polarity-switching circuitry. If the welding electrodes are improperly connected for a particular welding-type operation (e.g., if one of the welding electrodes is not connected, or if the polarity of the welding electrodes is reversed), the welding-type operation may be adversely affected. Thus, it may be desirable to ensure that the polarity of the welding electrodes is correct to improve the efficiency of the welding-type operation.

The present disclosure relates to welding-type systems configured to automatically set the polarity based on operator selected welding parameters in order to reduce operator error and/or reduce the time required for an operator to physically swap the welding electrodes. Additionally, in some examples the power supply may be physically distant from the welding operation, and a remote device is used for detection and/or correction of the polarity at a location that is proximal to the welding-type operation. The remote device may transmit signals defining the operational parameters of the welding operation to and from the power supply, generally referred to as remote control.

While automatically selecting the polarity is desirable in many or most scenarios, in some situations, a welding operator may wish to override an automatically selected polarity. For example, an operator may perform a welding operation with an atypical filler metal in which it is desirable to operate in the opposite polarity from the automatically selected polarity. Accordingly, the present disclosure relates to a welding-type system configured to enable the operator to override the polarity that is automatically selected by the welding-type system based on the selected welding parameters.

Disclosed example welding-type power supplies include power conversion circuitry configured to output welding-type power; and control circuitry configured to: detect a welding process based on one or more received welding parameters; automatically set an output polarity of the welding-type power to a first polarity based on the detected welding process; receive an override command; and control the power conversion circuitry to output the welding-type power having a second polarity in response to the override command.

Some example welding-type power supplies further include a user interface, wherein the one or more received welding parameters are received via the user interface.

Some example welding-type power supplies further include a user interface, and the override command is received via the user interface.

Some example welding-type power supplies further include a user interface, and the user interface displays the set output polarity.

Some example welding-type power supplies further include communications circuitry, and the control circuitry is configured to receive, via the communications circuitry, a first signal from a remote welding device indicating the output polarity of the welding operation detected by the remote welding device, and the control circuitry is configured to automatically set the output polarity to the first polarity based on the first signal.

Some example welding-type power supplies further include communications circuitry, and the control circuitry receives the override command from a remote welding device via the communications circuitry.

In some example welding-type power supplies, the communications circuitry is configured to communicate with the remote welding device via weld cable communications.

In some example welding-type power supplies, the communications circuitry is configured to communicate with the remote welding device via a wired connection.

In some example welding-type power supplies, the communications circuitry is configured to communicate with the remote welding device via a wireless connection.

In some example welding-type power supplies, the one or more welding parameters includes a selected welding mode.

In some example welding-type power supplies, the selected welding mode is one of gas metal arc welding (GMAW), flux cored arc welding (FCAW), shielded metal arc welding (SMAW), gas tungsten arc welding (GTAW), or carbon arc cutting/gouging.

In some example welding-type power supplies, the control circuitry is configured to detect the selected welding mode based on a detection of a welding torch type.

Disclosed example remote welding devices coupled to a welding-type power supply via a weld cable include: a user interface; communications circuitry; and control circuitry configured to: detect a welding process based on a received welding parameter; output, via the user interface, an indication of a polarity of welding-type power output by the welding-type power supply; receive, via the user interface, an override command; and transmit, via the communications circuitry, the override command to the welding-type power supply, wherein the override command commands the welding-type power supply to output a polarity different than the first polarity selection.

In some example remote welding devices, the communications circuitry is configured to communicate with the power supply via a wireless connection.

In some example remote welding devices, the communications circuitry is configured to communicate with the power supply via weld cable communications.

In some example remote welding devices, the communications circuitry is configured to communicate with the power supply via a wired connection.

In some example remote welding devices, the remote welding device is a wire feeder.

In some example remote welding devices, the remote welding device is a welding pendant.

In some example remote welding devices, the one or more welding parameters includes a selected welding mode.

In some example remote welding devices, the selected welding mode is one of gas metal arc welding (GMAW), flux cored arc welding (FCAW), shielded metal arc welding (SMAW), gas tungsten arc welding (GTAW), or carbon arc cutting/gouging.

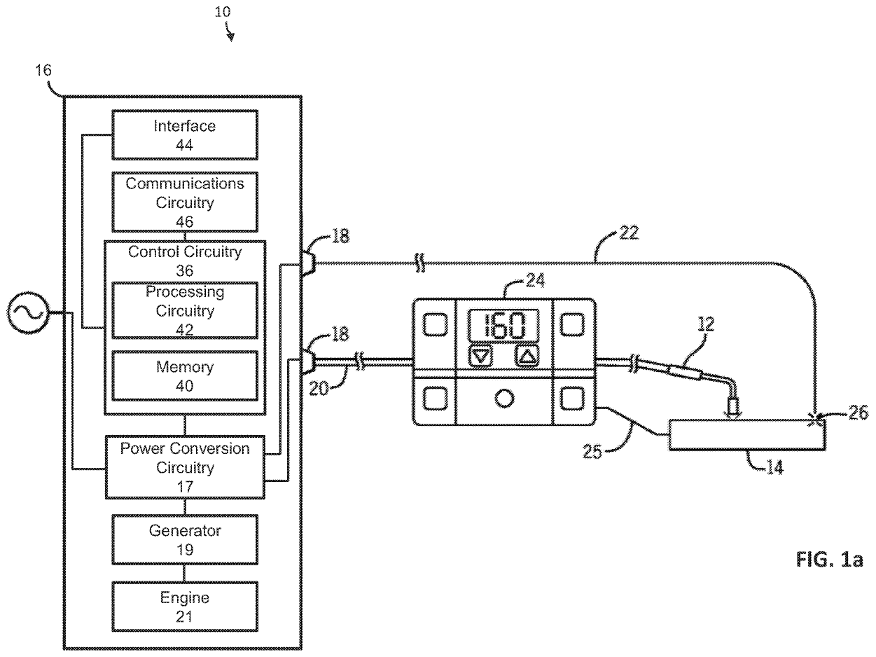

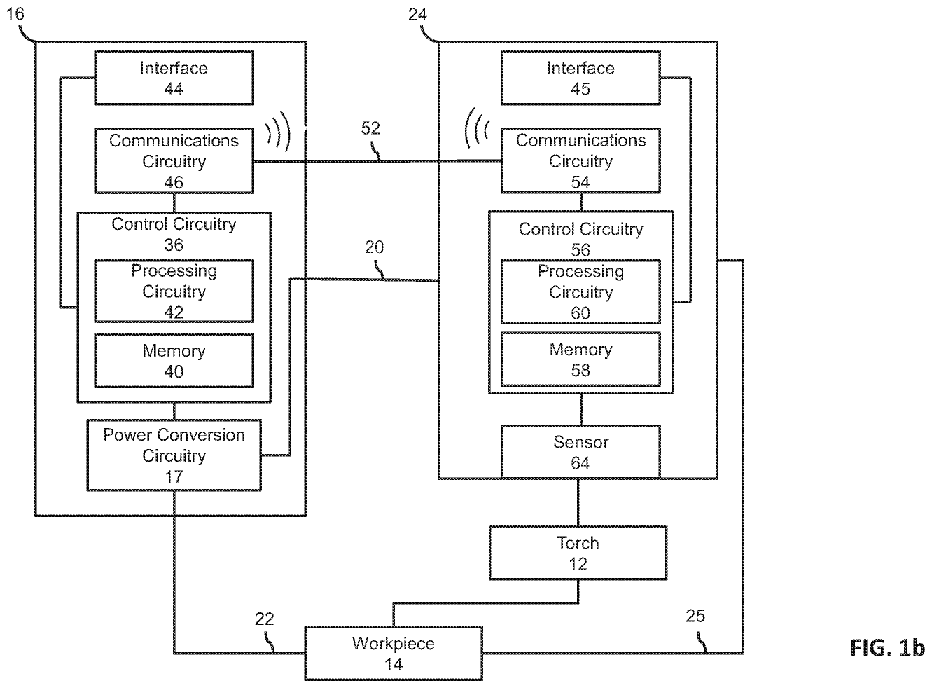

FIG. 1a illustrates an example welding system 10 that includes a welding torch 12, a workpiece 14, and a welding-type power supply 16. The welding-type power supply 16 includes power conversion circuitry 17 configured to receive input power (e.g., from mains power, a generator, etc.) and convert the input power to welding-type output power. In some examples, the power conversion circuitry 17 includes circuit elements (e.g., transformers, rectifiers, capacitors, inductors, diodes, transistors, switches, and so forth) capable of converting the input power to output power. In some examples, the power conversion circuitry 17 also includes one or more controllable circuit elements. In some examples, the controllable circuit elements include circuitry configured to change states (e.g., fire, turn on/off, close/open, etc.) based on one or more control signals. In some examples, the state(s) of the controllable circuit elements may impact the operation of the power conversion circuitry 17, and/or impact characteristics (e.g., current/voltage magnitude, frequency, waveform, etc.) of the output power provided by the power conversion circuitry 17. In some examples, the controllable circuit elements includes, for example, switches, relays, transistors, etc. In examples where the controllable circuit elements comprise transistors, the transistors may comprise any suitable transistors, such as, for example MOSFETs, JFETs, IGBTs, BJTs, etc.

In some examples, the welding-type power supply 16 includes an engine 19 and a generator 21 which converts the mechanical power provided by the engine 19 to electrical power which is provided to the power conversion circuitry 17. In some examples, as explained above, the welding-type power supply 108 may omit an engine and generator and the power conversion circuitry 132 may receive power from another source, such as mains power.

The welding-type power supply 16 includes multiple studs 18 that may accommodate one or more welding electrodes to form an electrical circuit to facilitate a welding operation. As illustrated, the power conversion circuitry 17 of the power supply 16 provides welding-type power to the welding torch 12 via a welding torch cable 20. The welding torch cable 20 is connected to one of the studs 18 (e.g., a positive stud). In addition, a work cable 22 is connected to one of the studs 18 (e.g., a negative stud, or the opposite stud to which the welding torch cable 20 is connected) and the workpiece 14 via a clamp 26. The welding torch cable 20 and the work cable 22 form a complete circuit between the power conversion circuitry 17, the welding torch 12, and the workpiece 14. When welding-type power is applied by the welding-type power supply 16 (via the power conversion circuitry 17), heat is generated, causing the workpiece 14 to transition to a molten state, thereby facilitating the welding operation.

In conventional welding-type systems, the connection of the welding torch cable 20 and the work cable 22 to the studs 18 defines a polarity of the welding operation (e.g., a positive polarity or a negative polarity). Swapping the welding torch cable 20 and the work cable 22 switches the polarity (e.g., change the positive polarity to a negative polarity or vice versa). Different welding processes are more efficient and/or produce better results with the recommended polarity. For example, stick welding may generally be performed with an electrode positive polarity (e.g., direct current electrode positive, or DCEP). As another example, gas tungsten arc welding (“GTAW”) may generally be performed with an electrode negative polarity (e.g., direct current electrode negative, or DCEN). However, with certain non-typical filler metals, a welding process may be more efficient with the reverse polarity (reverse with reference to the typical polarity for the given welding operation). For example, when welding with some filler metals, a GTAW process may be more efficient with a DCEP polarity. As another example, when welding with some non-typical filler metals, a stick welding process may be more efficient with a DCEN polarity. As another example, FCAW-S welding may typically use a DCEN polarity. Some atypical American Welding Society classifications of FCAW-S electrodes (e.g., E70T-3, E70T-4 and E70T-6), however, are designated to use a DCEP polarity.

When the polarity configuration of the welding equipment does not match the welding process, it may be time consuming for an operator to physically swap the cables 20, 22. In certain welding systems, the cables 20, 22 may be hundreds of feet long, and the power supply 16 may be physically distant from the welding operation. To reduce operator error and/or time involved to swap cables at the power supply 16, it may be desirable to automatically select a polarity based on selected welding parameters, such as a selected welding process. Further, it may be desirable to detect, communicate, and/or control the polarity using a remote device 24 disposed at a remote location that is proximal to the welding torch 12. The remote device 24 may be, for example a wire feeder, a welding pendant, or any other remote control device capable of communicating with the power supply 16.

As illustrated in the example system 10 of FIG. 1a, the remote device 24 is a separate, portable device that may be connected to the welding torch cable 20 between the power supply 16 and the welding torch 12. As illustrated in in the example system 10 of FIG. 1a, the remote device 24 is connected in line with, and is powered by, the welding torch cable 20. A work sensing line 25 is coupled to the remote device 24 and the workpiece 14 to enable the remote device 24 to receive power and detect the polarity even when the welding torch 12 is not operating. More specifically, the work sensing line 25 completes an electrical circuit between the power supply 16, the remote device 24, the workpiece 14, and back to the power supply 16 to enable the polarity to be detected. In some examples, rather than being in line with the power supply 16 and powered by the power supply 16 (e.g., via the welding torch cable 20), the remote device 24 may be powered independently of the power supply 16 and may communicate via a separate wired connection or wirelessly with the power supply 16. In some examples, the work cable 22 and torch cable 20 are both connected to the remote device 24 (e.g., both the work cable 22 and the torch cable 22 come out of the remote device). In some examples where the work cable and the torch cable 20 are both connected to the remote device 24, swapping the work cable 22 and the torch cable that are connected to the remote device 24 switches the polarity.

The remote device 24 includes a user interface 45 (e.g., display and control features) that is substantially similar to the user interface 44 (e.g., display and control features) on the power supply 16. The user interface 45 includes a display for displaying parameters of the welding operation (e.g., for displaying the voltage and/or amperage of the welding operation), and control features for selecting welding parameters. For example, the control features may be used for increasing or decreasing the amperage or voltage of the welding operation, switching between welding operations (e.g., gas tungsten arc welding (“GTAW”), Stick welding, gas metal arc welding (“GMAW”), flux cored arc welding (“FCAW”), shielded metal arc welding (“SMAW”), carbon arc cutting/gouging, etc.), setting a type of welding electrode, etc. The user interface 45 of the remote device 24 includes similar functionality as the user interface 44 of the power supply 16 for displaying and adjusting welding parameters of the welding operation.

As illustrated, the power supply 16 includes control circuitry 36. The control circuitry 36 includes processing circuitry 42 (e.g., one or more processors) as well as analog and/or digital memory 40. The control circuitry 36 is configured to control the power conversion circuitry 17, so as to ensure the power conversion circuitry 17 generates the appropriate welding-type output power for carrying out the desired welding-type operation. The memory 40 may store instructions or programs, which may be executed by the processing circuitry 42. The memory 40 may also store historical data or other programming instructions. For example, the memory 40 may store and associate various types of welding processes with the preferred welding polarities (e.g., DCEP or DCEN) for each welding process.

The control circuitry 36 is configured to control the power conversion circuitry 17 based on the polarity of the welding operation. For example, if the polarity of the welding operation is inappropriate, the control circuitry 36 may automatically send a signal to switch the polarity. To this end, in certain embodiments, the power conversion circuitry 17 may include polarity reversing switches, and the control circuitry 36 may send a signal to open or close these switches.

The user interface 44 may include input devices such as a touchscreen, keypad, stylus, buttons, dials, or any other input device capable of receiving input from an operator. The user interface 44 also includes a display screen to display graphics, buttons, icons, text, windows, and similar features relating to information about the welding system 10. For example, the user interface 44 may display graphical indicators of welding parameters, messages indicating a status of the welding system 10, or both. For example, the user interface 44 may display the polarity and/or indicate if the polarity was automatically set (e.g., switched). The user interface 44 may also present an option to override the automatic polarity selection. For example, the user interface 44 may include an override button or may display an override option on a touchscreen display. In some examples, the override option may be selected before selecting a welding process, such that the automatic polarity selection feature is disabled. In some examples, the user interface 44 alerts the operator when the polarity was automatically selected, and then give the operator the option of overriding (e.g., switching back) the automatic polarity selection. In some examples, the user interface 44 displays the current polarity and present an option to switch the current polarity.

FIG. 1b is a schematic diagram of the welding system 10 of FIG. 1a, illustrating communication between the remote device 24 and the power supply 16. As illustrated, the power supply 16 includes the user interface 44 and the control circuitry 36. The power supply 16 also includes communications circuitry 46 that is configured to communicate with the remote device 24. As illustrated in FIG. 1b, in some examples, the communications circuitry 46 may communicate with the remote device 24 using wireless communications (e.g., wireless signals 48, 50). In some examples, the communications circuitry 46 may communicate with the remote device 24 using weld cable communications (WCC) through the welding torch cable 20. In some examples, wired communication between the power supply 16 and the remote device 24 may be provided via a communication cable 52.

As shown, the remote device 24 also includes a user interface 45. As discussed above, in some examples, the user interfaces 44, 45 of the power supply 16 and the remote device 24 may be substantially similar, and each user interface 44, 45 may allow for selecting welding parameters of the welding operation. As previously noted, the welding torch cable 20 and the work cable 22 may be hundreds of feet long, and having the remote device 24 proximate to the welding torch 12 may improve the operability of the welding system 10.

The remote device 24 includes communications circuitry 54 that is communicatively coupled to the power supply 16. The communications circuitry 54 may communicate with the communications circuitry 46 of the power supply 16 using wireless communications, WCC through the welding torch cable 20, or the communication cable 52. The remote device 24 also includes control circuitry 56. In some examples, the control circuitry 56 is configured to detect the polarity of the welding operation. In some examples, the control circuitry 56 includes memory 58 which may store programming instructions, software programs, and/or historical data. The control circuitry 56 may also include processing circuitry 60 (e.g., one or more processors), among others types of processing devices, configured to execute instructions stored in the memory 58. In particular, the processing circuitry 60 may implement software instructions stored in the memory 58 to detect the polarity of the welding operation.

In some examples, the control circuitry 56 is configured to detect the polarity of the welding operation and transmit the polarity information to the control circuitry 36 of the power supply 16 via the communication circuitry 46, 54. When the control circuitry 36 of the power supply 16 receives the polarity information, the control circuitry 36 may determine if the polarity is appropriate based on parameters of the welding system 10, which may be set using either the interface 44 of the power supply 16 or the interface 45 of the remote device 24. These parameters may include a type of welding process (e.g., stick, GTAW, carbon arc cutting/gouging, or other type of welding process), and may be input by an operator via either of the interfaces 44, 45. If the polarity is inappropriate for the given selected parameters of the welding system 10, the control circuitry 36 controls the power conversion circuitry 17 to automatically switch the polarity, for example by switching polarity reversing switches in the power conversion circuitry 17. The control circuitry 36 may also control the user interface 44 to display a message that the polarity was automatically switch. The user interface 44 may also present a selectable override option, which when selected by the operator will override the automatically selected polarity (e.g., switch the automatically selected polarity).

Example implementations of welding-type systems that automatically select an output polarity are described in U.S. Pat. No. 10,259,067 by Edward Beistle et. al., filed Apr. 29, 2013, titled “Remote Polarity Detection And Control For Welding Process.” The entirety of in U.S. Pat. No. 10,259,067 is incorporated by reference. Example implementations of welding-type systems that determine an output polarity are described in U.S. Pat. No. 9,902,008 by James Rappl et. al., filed Feb. 27, 2018, titled “Systems and Methods for Selecting a Welding Process.” The entirety of U.S. Pat. No. 9,902,008 is incorporated by reference. Example implementations of a pendant that allows an operator to reverse an output polarity are described in U.S. Pat. No. 8,330,077 by James Rappl et. al, filed Sep. 3, 2009, titled “Remote Welding System and Method.” The entirety of U.S. Pat. No. 8,330,077 is incorporated by reference.

The control circuitry 36 may also transmit a message to the control circuitry 56 of the remote device 24 via the communications circuitry 54 and 46 indicating that the polarity was automatically selected (e.g., switched). Upon receiving the message, the control circuitry 56 may control the user interface 45 of the remote device 24 to present an selectable override option, which when selected by the operator will cause the control circuitry 56 of the remote device 24 to transmit a message via the communications circuitry 54 and 45 to the control circuitry 36 of the power supply 16 to override the automatically selected polarity (e.g., switch the automatically selected polarity).

As described above, in some examples the control circuitry 56 of the remote device 24 detects a polarity and communicates the polarity to the control circuitry 36 of the power supply 16, which determines if the polarity is appropriate and automatically switched the polarity if it not appropriate (e.g., automatically switches the polarity). However, in some examples, these functions may be allocated differently between the control circuitry 36, 56. For example, the control circuitry 56 of the remote device 24 may detect the polarity, receive the welding parameters input via the interfaces 44, 45, and determine if the polarity is appropriate (e.g., instead of the control circuitry 36 of the power supply 16 determining if the polarity is appropriate). The control circuitry 56 of the remote device 24 may send a signal to the control circuitry 36 of the power supply 16 via the communications circuitry 54 and 46 to automatically switch the output polarity. The control circuitry 36 then controls the power conversions circuitry 17 to switch the output power polarity. The control circuitry 56 may also control the user interface 45 to display a message that the polarity was automatically switched. The user interface 45 may also present a selectable override option, which when selected by the operator will cause the control circuitry 56 of the remote device 24 to transmit a message via the communications circuitry 54 and 46 to the control circuitry 36 of the power supply to override the automatically selected polarity (e.g., switch the automatically selected polarity).

In some examples, the control circuitry 36 of the power supply 16 and/or the control circuitry 56 of the remote device 24 are configured to automatically select the output power polarity without first detecting an output power polarity. For example, when an operator selects a particular welding process via the user interface 44, the control circuitry 36 of the power supply 16 may automatically configure the power conversion circuitry to output welding-type polarity at the appropriate polarity for the selected welding process. For example, some welding systems 100 may omit a remote device 24 and may automatically select the output polarity based on the selected welding parameters (e.g., the selected welding process). In some examples, the user interface 44 may display the current polarity and present an option to switch the current polarity.

In some examples, when a user selects a particular welding process via the user interface 45, the control circuitry 56 of the remote device 24 may automatically determine the appropriate polarity for the selected welding process, and then transmit a message to the control circuitry 36 of the power supply 16 via the communications circuitry 54 and 46 commanding the control circuitry 36 of the power supply 16 to control the power conversion circuitry to output welding-type polarity at the determined appropriate polarity for the selected welding process. In some examples, the user interface 45 may display the current polarity and present an option to switch the current polarity.

As another example, when a when a user selects a particular welding process via the user interface 45, the control circuitry 56 transmits a message to the control circuitry 36 of the power supply 16 via the communications circuitry 54 and 46 communicating the selected welding process. The control circuitry 36 then automatically configures the power conversion circuitry to output welding-type polarity at the appropriate polarity for the selected welding process. The user interfaces 45 and 44 may display the selected polarity and present a selectable override option to override the automatically selected output polarity, as described above.

In some examples where the work cable and the torch cable 20 are both connected to the remote device 24, the remote device 24 may include polarity reversing circuitry (e.g., polarity reversing switches) and the control circuitry 56 may control the polarity reversing circuitry of the remote device to automatically select the polarity based on selected welding parameters, as discussed above. Similarly, the control circuitry 56 may receive a user selected override command and control the polarity reversing circuitry to switch the automatically selected polarity.

In some examples, rather than a selected welding process, the control circuitry 56 or 36 may detect a torch type that is connected to the power supply 16, and the output power polarity may be automatically selected based on the detected torch type. For example, the remote device 24 or the power supply 16 (e.g., in system that does not include a remote device 24), may include a sensor 64 configured to determine which type of welding torch (e.g., GTAW, GMAW, FCAW, SMAW, stick, carbon arc cutting/gouging, etc.) is connected. As described above, the control circuitry 36 or 56 then automatically determines the appropriate output polarity and controls the power conversion circuitry accordingly.

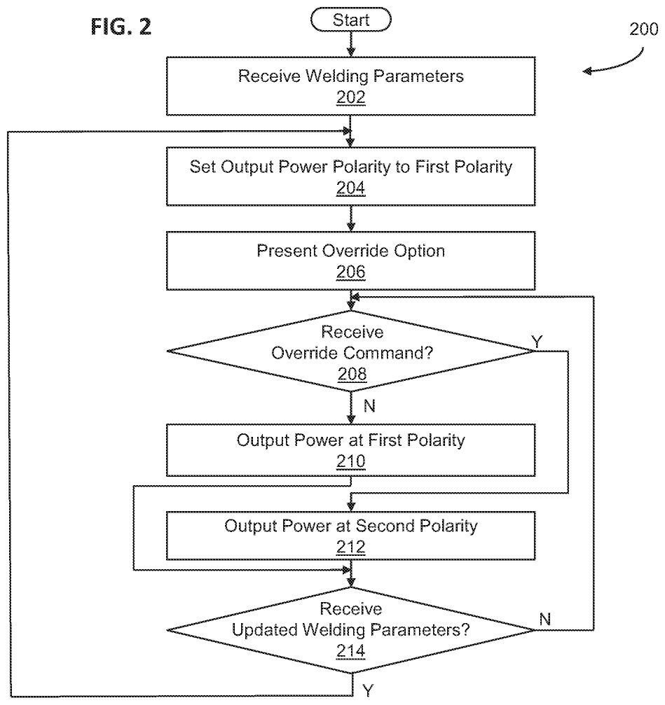

FIG. 2 is a flowchart representative of machine readable instructions 200 which may be executed by the example welding-type power supply 16 and/or the remote device 24 for setting the output polarity of a welding-type power supply for a welding-type operation, for example the welding-type power supply 16 of the illustrated example of FIGS. 1a and 1b. In some examples, the instructions 200 may be stored in the memory 40 and/or executed by the processing circuitry 42 of the welding welding-type power supply 16. In some examples, the instructions 200 may be stored in the memory 58 and/or executed by the processing circuitry 58 of the remote device 24.

At block 202, the processing circuitry 42 receives selected welding parameters, for example operator selected welding parameters received via the user interface 44. For example, an operator may select a particular welding process (e.g., GTAW, GMAW, FCAW, SMAW, stick, carbon arc cutting/gouging) via the user interface 44. At block 24, the processing circuitry 42 sets the output polarity to a first polarity based on the received welding parameters. For example, the memory 40 may include a lookup table or database that associates particular welding parameters (e.g., particular welding processes) with particular output polarities. At block 206, the processing circuitry 42 controls the user interface 44 to display the first polarity (e.g., the automatically selected polarity) and also present a selectable option for the operator to override the automatically selected polarity. At block 208, the processing circuitry checks to determine whether the operator selected the override option. If the operator does not select the override option (block 208) then at block 210 the processing circuitry 42 controls the power conversion circuitry 17 to output welding-type power at the first polarity. If the operator does select the override option (block 208), then at block 213 the processing circuitry 42 controls the power conversion circuitry 17 to switch the polarity to a second polarity and output welding-type power at the second polarity. Then at block 214 the processing circuitry checks to determine if updated welding parameters were received. If updated welding parameters were not received (block 214), the processing circuitry returns to block 208. If updated welding parameters were received (block 214), the processing circuitry returns to block 204.

The present method and/or system may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, the terms “control circuit” and “control circuitry,” may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards, that form part or all of a controller, and are used to control a welding process, a device such as a power source or wire feeder, motion, automation, monitoring, air filtration, displays, and/or any other type of welding-related system.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor 130.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type power refers to power suitable for welding, cladding, brazing, plasma cutting, induction heating, carbon arc cutting, and/or hot wire welding/preheating (including laser welding and laser cladding), carbon arc cutting or gouging, and/or resistive preheating.

As used herein, a welding-type power supply and/or power source refers to any device capable of, when power is applied thereto, supplying welding, cladding, brazing, plasma cutting, induction heating, laser (including laser welding, laser hybrid, and laser cladding), carbon arc cutting or gouging, and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A welding-type power supply comprising:
power conversion circuitry configured to output welding-type power; and
control circuitry configured to:
detect a welding process based on one or more received welding parameters;
automatically set an output polarity of the welding-type power to a first polarity based on the detected welding process;
receive an override command; and
control the power conversion circuitry to output the welding-type power having a second polarity in response to the override command.

2. The welding-type power supply of claim 1, further comprising a user interface, wherein the one or more received welding parameters are received via the user interface.

3. The welding-type power supply of claim 1, further comprising a user interface, wherein the override command is received via the user interface.

4. The welding-type power supply of claim 1, further comprising a user interface, wherein the user interface displays the set output polarity.

5. The welding-type power supply of claim 1, further comprising communications circuitry, wherein the control circuitry is configured to receive, via the communications circuitry, a first signal from a remote welding device indicating the output polarity of the welding operation detected by the remote welding device, and wherein the control circuitry is configured to automatically set the output polarity to the first polarity based on the first signal.

6. The welding-type power supply of claim 1, further comprising communications circuitry, wherein the control circuitry receives the override command from a remote welding device via the communications circuitry.

7. The welding-type power supply of claim 6, wherein the communications circuitry is configured to communicate with the remote welding device via weld cable communications.

8. The welding-type power supply of claim 6, wherein the communications circuitry is configured to communicate with the remote welding device via a wired connection.

9. The welding-type power supply of claim 6, wherein the communications circuitry is configured to communicate with the remote welding device via a wireless connection.

10. The welding-type power supply of claim 1, wherein the one or more welding parameters comprises a selected welding mode.

11. The welding-type power supply of claim 10, wherein the selected welding mode is one of gas metal arc welding (GMAW), flux cored arc welding (FCAW), shielded metal arc welding (SMAW), gas tungsten arc welding (GTAW), carbon arc cutting, or carbon arc gouging.

12. The welding-type power supply of claim 8, wherein the control circuitry is configured to detect the selected welding mode based on a detection of a welding torch type.

13. A remote welding device communicatively coupled to a welding-type power supply via a weld cable, the remote welding device comprising:
a user interface;
communications circuitry; and
control circuitry configured to:
detect a welding process based on a received welding parameter;
output, via the user interface, an indication of a polarity of welding-type power output by the welding-type power supply;
receive, via the user interface, an override command; and
transmit, via the communications circuitry, the override command to the welding-type power supply, wherein the override command commands the welding-type power supply to output a polarity different than the first polarity selection.

14. The remote welding device of claim 13, wherein the communications circuitry is configured to communicate with the power supply via a wireless connection.

15. The remote welding device of claim 13, wherein the communications circuitry is configured to communicate with the power supply via weld cable communications.

16. The remote welding device of claim 13, wherein the communications circuitry is configured to communicate with the power supply via a wired connection.

17. The remote welding device of claim 13, wherein the remote welding device is a wire feeder.

18. The remote welding device of claim 13, wherein the remote welding device is a welding pendant.

19. The remote welding device of claim 13, wherein the one or more welding parameters comprises a selected welding mode.

20. The remote welding device of claim 19, wherein the selected welding mode is one of gas metal arc welding (GMAW), flux cored arc welding (FCAW), shielded metal arc welding (SMAW), gas tungsten arc welding (GTAW), carbon arc cutting, or carbon arc gouging.
